(19) United States
(12) Patent Application Publication
(10) Pub. No.: US 2025/0078119 A1
(43) Pub. Date: Mar. 6, 2025

(54) SYSTEM AND METHOD FOR PROVIDING AN INTERNET OF THINGS MANAGEMENT PLATFORM

(71) Applicant: Zach Bolton, Marana, AZ (US)

(72) Inventor: Zach Bolton, Marana, AZ (US)

(21) Appl. No.: 18/807,150

(22) Filed: Aug. 16, 2024

Related U.S. Application Data
(60) Provisional application No. 63/536,076, filed on Sep. 1, 2023.

(51) Int. Cl. G06Q 30/0251; G06K 19/07

(52) U.S. Cl. CPC G06Q 30/0267; G06K 19/0723

(57) ABSTRACT

The invention provides a client-user interaction platform that enables a client to interact with users through a mobile device. The platform includes a client interface, creation tools for custom wallet app content, triggers associated with users, and a linker for associating triggers with the content. A tracker for logging user interactions, a wallet pass API mapper, and a dashboard summarizing the client's content, triggers, and users may be provided. The triggers can be a Bluetooth beacon, a QR Code, a 2-way SMS, an NFC tag, a location, or a trackable link. The wallet app content can include custom created campaign items such as emails, SMS, or push notifications scheduled to a marketing strategy that adapts to user preferences, behaviors, and engagement patterns. The platform may incorporate information from sensors into the content and provide methods for managing storage units and facilitating visits to a site using the platform.

### BACKGROUND OF THE INVENTION

### Field of the Invention

The present invention relates to the intersection of the mobile and the physical world, and

specifically, to the use of mobile communication devices to facilitate improved consumer experiences in retail environments.

### Description of Related Art

Traditional retail has long had an issue of valuable offers and targeted ads. Search engines and behavioral e-commerce targeting engines have helped decrease the amount of wasted advertising in the realm of online shopping by about 50%. Mobile devices and targeted applications have greatly improved the ability of retailers to get to know customer preferences, habits, and past experiences and can tailor offers accordingly. Current methods include real-time incentive programs [U.S. Pat. No. 6,292,786] and processes attempting to influence consumers at the point-of-sale [U.S. Pat. No. 5,918,211]).

Transaction-related information has been captured after the fact through methods like consumer loyalty programs, email enrollment, and Enterprise Resource Planning (ERP). Similarly, user experience has been captured post-event through avenues such as social media and Customer Relationship Management (CRM). However, the collection of real-time data is limited, typically confined to systems like point-of-sale (POS), payment gateways, or in-house/3rd party software specific to individual transactions or customers. Additional methods are being adapted to capture data related to other participants in the overall experience encompassing all customers, all employees of the businesses involved, the products or services associated with each customer/employee, and other pertinent information that directly influences the end-to-end customer experience. With all of this information, retailers are left on their own to devise applications, messaging, and programs incorporating all available information.

Improving customer experience using conventional methods can be categorized into two approaches: manual processes and mining transaction and social data. Mining transaction and social data can be employed by business software and/or third-party software vendors to gain insights into improving customer experience. However, the information acted upon fails to capture the entirety of the experience.

Stored-value cards are now available in the digital space, known as electronic stored-value cards. Recent years have seen the emergence of a growing number of electronic wallet providers in response to the need for storing and managing electronic stored-value cards. Instantly issued virtual stored-value cards can come in two forms: cards redeemable at a specific merchant (Closed Loop Cards) or cards redeemable at multiple merchants (Open Loop Cards and Private Label Cards).

The electronic transaction market currently offers a multitude of credit cards, debit cards, stored value cards, and loyalty cards, all provided by various issuers, vendors, and providers. These cards serve different purposes, with some designed for redemption at specific retailers and others redeemed through financial institutions. Certain cards also come with promotional benefits, such as loyalty programs. However, the increasing number and complexity of these cards pose challenges in terms of organization and redemption, potentially impeding market growth. For instance, users may struggle to keep track of their stored value cards for specific stores among the abundance of cards they possess. Additionally, users may not fully comprehend the different promotional offers available when combining a card with a loyalty program, resulting in missed opportunities for benefits applicable to their purchases.

Historically, cards have been physical objects made of plastic, making them susceptible to loss, theft, or being forgotten at home when needed. As the number of card-based offerings for consumers continues to grow, individuals face the arduous task of organizing, managing, tracking, transporting, and storing their credit, debit, stored-value, loyalty, and other merchant-issued cards. What consumers need today is a more efficient, secure, and effective method of acquiring, accessing, and utilizing assets related to stored-value cards. To enhance the consumer experience, it would be beneficial to develop an improved system for retailers to be able to quickly and cheaply develop effective membership and loyalty programs without the need of creating a costly custom mobile device app.

Managing multiple apps on a smart device and cards for different vendors can be cumbersome, leading to clutter, security risks, fragmented loyalty rewards, increased financial risk, compatibility issues, limited features, maintenance effort, and environmental impact. This complexity makes it challenging to navigate various interfaces, increases the risk of security breaches, fragments loyalty rewards across platforms, may lead to overspending or financial mismanagement, causes compatibility conflicts, may result in missed functionalities, requires ongoing maintenance, and contributes to environmental waste.

To reduce the complexity and length of the Detailed Specification, and to fully establish the state of the art in certain areas of technology, Applicant(s) herein expressly incorporate(s) by reference all of the following materials identified in each numbered paragraph below. The incorporated materials are not necessarily “prior art” and Applicant(s) expressly reserve(s) the right to swear behind any of the incorporated materials.

U.S. Pub. No. 2017/0046679A1

AU Pub. No. 2019/200882A1

AU Pub. NO. 2016/266016A1

U.S. Pat. No. 10,346,621

U.S. Pat. No. 10,325,102

U.S. Pub. No. 2023/0033050A1

Applicant(s) believe(s) that the material incorporated above is “non-essential” in accordance with 37 CFR 1.57, because it is referred to for purposes of indicating the background of the invention or illustrating the state of the art. However, if the Examiner believes that any of the above-incorporated material constitutes “essential material” within the meaning of 37 CFR 1.57(c)(1)-(3), applicant(s) will amend the specification to expressly recite the essential material that is incorporated by reference as allowed by the applicable rules.

### BRIEF SUMMARY OF THE INVENTION

The present invention provides among other things a client user interaction platform for allowing a client to interact with one or more users associated with the client through a mobile device's wallet application.

It is an object of the invention to simplify creating content for a variety of clients.

It is another object of the invention to more fully take advantage of the functionality of the wallet application in popular operating systems.

It is another object of the invention to provide a content creation platform that simplifies creating the functionality of a typical custom mobile application.

It is another object of the invention to provide a uniform interface for creating a variety of custom content.

It is another object of the invention to provide an interface that allows simplified integration of real-world triggers into custom content.

It is another object of the invention to provide a simplified interface for integrating real world triggers into wallet app content.

It is another object of the invention to provide a platform integrating multiple real-world triggers into a single interface.

It is another object of the invention to provide a platform that dynamically manages a combination of at least one of Sim cards, Quick Response Codes, Near Field Communication tags, Bluetooth beacons, SMS, push notifications, geographical location tools and trackable links.

It is another object of the invention to provide a platform that allows reusing real-world triggers by dynamically managing sequentially assigned triggers.

It is another object of the invention to provide a single trigger including both Quick Response Code and Near Field Communication applications.

It is another object of the invention to provide a Near Field Communication tag that may be effectively used on a metal substrate.

It is another object of the invention to provide a simplified interface to create marketing campaigns using real world triggers to initiate content communication to users of a variety of clients.

It is another object of the invention to provide a simplified interface to provide custom special offers to users based on user activity physically and digitally.

It is another object of the invention to provide a simplified interface to provide custom special offers to users based on user location.

It is another object of the invention to provide a simplified interface for clients to track customer activities.

It is another object of the invention to provide a simplified interface for tracking check ins and manager inspections using NFC and QR Code interfaces.

It is another object of the invention to provide a simplified interface for tracking check ins and manager inspections using NFC and QR Code interfaces in the context of self-storage facilities.

It is another object of the invention to integrate NFC tags with locks for improved accessibility and monitoring of managed access spaces.

It is another object of the invention to integrate NFC tags with locks to selectively open a gate, door, or other access panels.

It is another object of the invention to simplify manager walk through inspections with improved oversight, time savings, and record keeping.

It is another object of the invention to use NFC tags and software application to confirm in operating software whether or not physical circumstances conform to the status present in management software.

It is another object of the invention to provide a value add to self-storage facilities using triggers integrated into user wallet app content with real world interactivity.

It is another object of the invention to integrate sensor monitoring of sites using wallet application content.

It is another object of the invention to provide a simplified interface for custom branding of wallet app passes.

It is another object of the invention to provide a simplified interface for creating a user experience at a location by allowing selective access of areas of the location and providing content based on the activity of the user.

It is another object of the invention to integrate HTML 5 location applications in real world internet of things applications.

It is another object of the invention to integrate wallet app content with other site management software by providing APIs through a simplified client interface.

It is another object of the invention to provide simplified graphic interactions with smaller data requirements using scalable vector graphics.

It is another object of the invention to allow clients to track staff performance using triggers and wallet app content on staff mobile devices.

It is another object of the invention to expand access to Internet of Things (IoT) applications for a wide variety of client industries.

The above and other objects may be achieved using devices involving a client-user interaction platform that allows a client to interact with one or more users associated with the client through a mobile device. The platform comprises a client interface that is accessible by one or more managers selected by the client. The client interface is designed to be user-friendly and intuitive, allowing managers to easily navigate through the platform and access its various features.

The platform also includes a set of creation tools provided through the platform that allow the client to create custom content. These creation tools are designed to be flexible and versatile, allowing the client to create a wide range of content tailored to their specific needs. The tools may be associated with real world triggers in an Internet of Things (IoT) application. The platform also provides interactions between the triggers and the content that allow clients to design and implement diverse interactions with the client's customers. The platform may include a stack set of IoT features which may be provided in a bundled solution or independently.

The creation tools may include, but are not limited to, a wallet pass builder, a landing page builder, and an email template builder. Content built on the creation tools may be used by the client to interact with customers using their mobile devices. The mobile device has an operating system and an operating system wallet application. In a particular embodiment, the platform uses existing functionality of the mobile device's wallet application to allow clients to use platform created content without the complexity or expense of building a custom application. The content builder on PHYREM's platform allows users to build mobile friendly content, such as emails, landing pages, and wallet passes. The wallet pass builder allows the client to create custom wallet passes, which can be used for a variety of purposes, such as loyalty programs, event tickets, and coupons. The wallet pass builder may include a variety of templates, such as a generic pass, a storage pass, a loyalty pass, a coupon pass, a member pass, an event ticket pass, a storpass, and a transit pass. The landing page builder allows the client to create custom mobile friendly landing pages, which can be used to direct users to specific content or actions. The landing page builder may include a variety of templates, such as a redirection page, a registration page, a payment page, a social media link, an issue reporting page, a photo gallery, an audio link, a vCard, a social media react page, a rate and review page, a feedback page, a video, an email us page, a text us page, a wifi login page, a business page, a maps page, an iFrame page, and a multiple links page. The email template builder allows the client to create custom mobile friendly email templates, which can be used for a variety of purposes, such as newsletters, announcements, and special offers. The email template builder may include a variety of templates, such as a holiday email, a basic announcement email, a basic letter email, a birthday email, a newsletter email, a special offer email, and a sign-up email. An SMS template builder may also be provided for common SMS messages such as appointment reminders, order confirmations, delivery notifications, promotional offers, feedback requests, account verification, payment reminders, event invitations, password resets, and survey requests.

The platform also includes one or more triggers that are each associated with and accessible by at least one of the one or more users. These triggers can be a variety of things, such as a Bluetooth beacon, a Quick Response Code, a 2-way SMS, a Near Field Communication tag, a geographical location, and a trackable link. Triggers may be uniquely identified sequentially and dynamically managed by the platform. The triggers are designed to initiate specific actions or events when activated by a user. For example, a trigger could be used to send a push notification to a user's mobile device when they enter a specific geographical location. The platform may include a database linking each trigger to an action. Clients can dynamically manage the actions that are linked to the trigger so that they can adjust the interactions with end users when the user engages with the trigger. When the trigger is engaged by a user, an enquiry is sent to the platform and the platform directs the content or action that is initiated by the trigger. The platform allows the client to assign an action to the trigger and to reassign or edit actions or content that is provided when the trigger is activated.

The platform also includes a linker that allows the client to associate the one or more triggers with the wallet app and other content. This allows the client to create a seamless and integrated user experience, where the activation of a trigger leads to the display or delivery of specific wallet app content or landing page. The platform may also include a tracker that logs user interactions with the one or more triggers or with the wallet app and other content. This allows the client to monitor and analyze user behavior, which can be used to inform future content creation and marketing strategies. The tracker may provide a graphical depiction of the logged interactions, providing a visual representation of user behavior.

The platform may also include a wallet pass API mapper, which allows the client to map wallet pass data to specific API endpoints. This allows the client to integrate the platform with other systems and services, further enhancing the functionality and versatility of the platform. The platform may also include a map tool that allows the client to create a custom geographic or location map. This can be used to visually represent the location of triggers, users, or other relevant data. At least one of the one or more triggers may be depicted on the map, providing a visual representation of the trigger's location.

The platform may also include a dashboard that summarizes the client's content, triggers, and users. This provides the client with a high-level overview of their use of the platform, allowing them to easily monitor and manage their content and users. The platform is designed to be flexible and adaptable, allowing the client to customize the content to their specific needs. For example, if the client has a plurality of locations, the content can be customized to at least one of the plurality of locations. This allows the client to provide a tailored and localized user experience.

The platform may also include at least one sensor, which can be used to gather additional data and enhance the functionality of the platform. Information from the sensor can be incorporated into the custom wallet app content, providing a more dynamic and interactive user experience. The sensor may be a motion sensor, a humidity sensor, a temperature sensor, a camera or light sensor, or a water sensor.

In one embodiment, the client may be a storage facility, and the one or more triggers may be Near Field Communication tags. In this case, the wallet app content may allow gate access to a user. This provides a convenient and secure method of access control, where a user can gain access to the storage facility or other gate accessed controlled facilities by simply placing their mobile device in proximity to the Near Field Communication tag reader. In another embodiment, the platform may be used to manage a plurality of storage units, each leased by a tenant. In this case, the client of the platform may be the owner or operator of the plurality of storage units. The tenants may be enrolled as users of the platform and assigned a unique user identifier. The user identifier can be linked to at least one gate or door, and the gate can be configured to open when the mobile device of the tenant is placed in proximity to the Near Field Communication tag reader. This provides a convenient and secure method of access control, where a tenant can gain access to their storage unit by simply placing their mobile device in proximity to the Near Field Communication tag reader.

In another embodiment, the platform may be used to facilitate visits to a site. In this case, the client content may include a map and customized locations of interest for each user identified on the map. Site maps may be provided as scalable vector graphics. Scalable Vector Graphics (SVG) is an XML-based vector image format used to describe two-dimensional vector graphics. SVG represents images using mathematical formulas that define shapes, lines, curves, colors, and other graphical elements. The platform allows a client to add a site map and converts the site map to an SVG image. Clients can assign areas of interest that are specific to the client's users. Triggers may be used in conjunction with user identifiers to provide an updated image to the user that includes an area of interest specific to the user highlighted on the site map. Areas of interest may be indexed as coordinates in the SVG data for each of a client's users. Rather than storing a copy of the site map for each user with that user's areas of interest graphically highlighted, the platform may take the SVG image and insert graphical highlighting code into the SVG description at the location appropriate to the user on demand.

In a particular embodiment, a printout of the map may be provided at the site, along with a trigger on or near the printout. When the trigger is activated by the user, it initiates a display of the map on the user's mobile device, with the locations of interest of the user highlighted. This provides a convenient and interactive method of site navigation, where a user can easily locate and navigate to their locations of interest.

The present invention provides a versatile and flexible client-user interaction platform that allows a client to interact with one or more users through a mobile device. The platform includes a variety of features and tools that allow the client to create custom wallet app content, associate triggers with the content, track user interactions, and customize the content to their specific needs. The platform can be used in a variety of contexts, such as access control for storage facilities, management of storage units, ad campaign management, retail, event planning, and facilitation of site visits.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF THE SEVERAL VIEWS OF THE DRAWINGS

A more complete understanding of the present invention may be derived by referring to the detailed description when considered in connection with the following illustrative figures. In the figures, like reference numbers refer to like elements or acts throughout the figures.

FIG. 1a depicts a generic wallet pass on a mobile device created from a generic wallet pass template according to one or more embodiments of the invention.

FIG. 1b depicts a view of the “access more” link of the generic wallet pass of FIG. 1a on a mobile device screen.

FIG. 1c depicts an alternate generic wallet pass created using the generic wallet pass template of FIG. 1a.

FIG. 1d depicts the full content of the “access more” link of the generic wallet pass of FIG. 1c.

FIG. 2 depicts a front view of a gate control application created on the platform according to one or more embodiments of the invention.

FIG. 3 depicts a graphical representation of a coupon created on the platform according to one or more embodiments of the invention.

FIG. 4 depicts a graphical representation of an ad campaign that may be designed using the platform according to one or more embodiments of the invention.

FIG. 5a depicts a perspective view of a location displaying a map created and displaying a trigger associated with the platform according to one or more embodiments of the invention.

FIG. 5b depicts a representation of the map of FIG. 5a on the mobile device of a user provided through the platform according to one or more embodiments of the invention.

FIG. 6a-c is a flowchart representation of a sensor integration application according to one or more embodiments of the invention.

FIG. 7a-d is a flowchart representation of a checklist configuration application according to one or more embodiments of the invention.

FIG. 8a-b is a flowchart representation of a critical scenario according to one or more embodiments of the invention.

FIG. 9a-e is a flowchart representation of a checklist maintenance application according to one or more embodiments of the invention.

FIG. 10a-f is a flowchart representation of a mapping application according to one or more embodiments of the invention.

FIG. 11a-d is a flowchart representation of a status check application according to one or more embodiments of the invention.

Elements and acts in the figures are illustrated for simplicity and have not necessarily been rendered according to any particular sequence or embodiment.

### DETAILED DESCRIPTION OF THE INVENTION

In the following description, and for the purposes of explanation, numerous specific details are set forth to provide a thorough understanding of the various aspects of the invention. It will be understood, however, by those skilled in the relevant arts, that the present invention may be practiced without these specific details. In other instances, known structures and devices are shown or discussed more generally to avoid obscuring the invention. In many cases, a description of the operation is sufficient to enable one to implement the various forms of the invention, particularly when the operation is to be implemented in software. It should be noted that there are many different and alternative configurations, devices, and technologies to which the disclosed inventions may be applied. The full scope of the inventions is not limited to the examples that are described below.

In one application of the invention, an engagement platform is provided to allow retailers to create and manage content compatible with an internet of things (“IoT”) program. The Internet of Things (IoT) refers to the concept of connecting everyday physical objects or devices to the internet, allowing them to collect and exchange data with other devices, systems, or applications. These objects, often referred to as “smart” devices, can include anything from household appliances and wearable devices to industrial machinery and vehicles.

IoT devices typically consist of sensors, triggers, actuators, and communication components. Sensors gather data from the environment (e.g., user presence or activity, temperature, humidity, light levels), and actuators perform actions based on that data (e.g., adjusting thermostat settings, turning on lights). The devices are connected to the internet, enabling them to transmit and receive data, which can be further processed and analyzed in cloud-based or edge computing systems.

The platform provides a variety of triggers and content creation tools to provide clients with content that can be associated with the triggers and operated to effectively communicate with users. Triggers may be given a unique identifier and the unique identifier can be assigned to a client. The client can integrate the trigger into a wide variety of applications in the real world and use the platform to associate the trigger with an action or a piece of content. Triggers may be dynamically managed to provide different content or activities to allow the client to interact with users. The platform may also provide an identifier for each user and provide a custom action or custom content for each user that interacts with each trigger. Clients are able to conveniently organize and manage users and triggers through the platform.

In a particular embodiment, the platform further provides a digital wallet interface. The platform leverages existing wallet pass programs on popular operating systems such as iOS and Android. Wallet passes may be configured and deployed in a fraction of the time and cost of creating a custom mobile device app while retaining the same functionality.

Digital wallet mobile device applications allow users to store multiple digital cards, passes, identifications or tickets you would typically carry in your wallet or purse. The platform provides retailers or other businesses that are clients of the platform with templates and components for easy, self-service customization of consumer engagement content. Potential target markets for the platform include parks & rec, specialty eateries, retail, CBD, health & fitness, arts & crafts, entertainment, storage facilities, associations, fitness centers, country clubs, and universities. Individual businesses can customize wallet pass content, interactions, and notifications and integrate triggers into the wallet pass content.

In some embodiments, the platform provides a drag-and-drop content builder to customize design, layout, and content for a personalized and branded experience, improving user engagement and brand recognition on wallet applications on mobile devices. Clients may add images, logos, and custom colors to match their brand identity and create a cohesive visual appearance optimized for mobile viewing and incorporate dynamic fields and API-driven data for personalized content tailored to each user's mobile experience. Continued access to the platform allows clients to update content and information in real-time, ensuring users always have the most up-to-date details on their mobile devices. Content creation may be automated according to client preferences and past choices. The platform may communicate with client Customer Relationship Management (“CRM”) programs through an appropriate Application Programming Interface (“API”). The platform may import information or create default content based on the content accessed from the CRM. The API may be custom built to interact with the platform and integrate the CRM into the platform. CRM data may be reformatted and displayed in a manner that is consistent with the platform, allowing ease of use for platform clients. The data made be configured to be owned and controlled by the platform or the platform clients.

The platform may include a mobile-friendly email builder to allow clients to design responsive emails optimized for mobile devices. Clients may choose from a variety of pre-built templates optimized for mobile devices or create their own to suit any specific needs and preferences. The email builder may include built-in analytics, tracking user engagement and conversions on mobile devices to help refine marketing efforts. Clients may preview and test designs across various devices and email providers to ensure a consistent mobile experience for all recipients.

The platform also may include a mobile-friendly landing page builder to create responsive landing pages optimized for mobile devices. Clients may choose from a variety of pre-built landing page templates optimized for mobile devices or create their own to suit any specific needs and preferences. The landing page builder may include built-in analytics, tracking user engagement and conversions on mobile devices to help refine marketing efforts. Clients may preview and test designs across various devices and email providers to ensure a consistent mobile experience for all recipients.

In one or more embodiments, the platform includes a campaign feature. The campaign features use 2-way SMS for outgoing and incoming keyword responses establishing a personalized and interactive communication channel with users. The campaign feature may push notifications and emails to customers to deliver timely and relevant updates, offers, or alerts. Clients may design pre-scheduled and single-send campaigns based on user preferences and behavior. Platform provided APIs can allow users to integrate with external platforms for data-driven campaigns, enabling targeted and effective communication. Campaign triggers may include credit card expiration, overdue balances, birthdays, holidays, or other if/then rules or conditions. The client may design any rule or condition (“if”) that, when met, triggers specific actions or responses (“then”) to engage effectively with users. Client data may be connected to or cross referenced with other third party databases to provide hyper personalized communications or offers.

Typical if/then campaigns will typically (1) define objectives and goals (2) identify user scenarios (3) craft the ‘if’ conditions, (4) design the ‘then’ actions (5) develop a communications flow (6) test and iterate (7) implement and monitor, and (8) update and optimize. In defining objectives and goals, the client clearly outlines the goals of the communication campaign, typically defining if the aim is to provide information, solve problems, promote products, or gather feedback. Understanding the objectives will guide the design of the if/then rules.

Different scenarios or situations may then be identified where communication with one or more users is desired. These could include inquiries, support requests, purchase queries, physical location, account status, and more. Each scenario should be treated as a potential trigger for the if/then rules. For each scenario, the conditions are then defined that need to be met for the communication to be triggered. These conditions could be based on keywords, phrases, specific questions, or user behavior. Once the conditions are met, the appropriate actions area is defined for responses. This could involve sending predefined messages, providing links to resources, suggesting relevant products, triggering an action within a CRM, or forwarding the request to a human or artificial intelligence (AI) representative. Each “then” action caters to the specific needs of the scenario. The flow of the communication based on the different scenarios and their associated conditions may then be mapped and the sequence of interactions, the timing of responses, and the potential paths users might take within the interaction considered.

The program may be tested before deployment to ensure that the if/then logic works as expected. Sample inputs may be used to trigger the responses and verify that the correct actions are taken. The program may then be deployed the program through the platform, and performance monitored to identify areas for improvement. As more data and insights are gathered from user interactions, the if/then program may be refined and optimized for the if/then program. Conditions, actions, and communication flows may be updated to enhance the overall user experience and achieve communication goals.

The campaign feature may provide comprehensive scheduling for Email, SMS, and Push Notifications to efficiently manage and coordinate marketing campaigns across multiple channels and versatile campaign scheduling to create and execute marketing strategies that adapt to user preferences, behaviors, and engagement patterns. Campaign performance may be optimized by the platform monitoring, evaluating, and refining marketing strategies based on real-time data, user feedback and machine learning strategies. Trackable links may be embedded into SMS, Email, and Push Notifications to monitor user interactions and capture valuable insights on campaign performance. Links may redirect users to landing pages, CRM pages for reservations or other self-service functions, social media pages for likes, or aggregator sites for reviews. The platform may provide pre-built landing pages and email templates for campaigns.

Content that clients may create on the platform may include email templates, landing pages (mobile sites), wallet passes, or social media automatic postings. The content may be presented or be made available to client end customers or other users via one or more triggers. Triggers may include QR-Codes, Near Field Communication tags, SMS (inbound or outbound), trackable links or location-based technologies like geofences, and BLE beacons.

Wallet passes may be accessed by users using a Quick Response Code that may be accessed through the camera of the user's device, a near field communication (Near Field Communication) chip, or a link in an SMS notice or email sent to the user based on a trigger. Geofences or Bluetooth low energy (BLE) beacons, pre-scheduled or real-time push notifications may be used to push notifications to the user's lock screen to allow users to access updates, special offers, or information selected by the client.

QR (Quick Response) codes provide a 2D barcode linked to a landing page. The 2D barcode may be read by most mobile device cameras. Quick Response Code landing pages may include useful information, activate features, loyalty program enrollment, social media pages, or reviews or feedback forms. Quick Response Codes are easily integrated with print materials to provide quick access and improve user experience. The platform may track landing page access to track user engagement for insights and analytics to help optimize marketing efforts.

Near Field Communication (Near Field Communication) tags are small, wireless devices that use Near Field Communication technology to establish communication with Near Field Communication-enabled devices, typically smartphones or tablets. These tags contain information that can be read and processed by the Near Field Communication-capable device when brought into close proximity, usually within a few centimeters. Near Field Communication stickers may be placed on windows, doors, or on a door with a window. If a Near Field Communication sticker is placed on a metal surface, a radio frequency (“RF”) blocker chip may be used to act as a magnetic shield to allow the Near Field Communication sticker to function without undue RF interference.

The platform enables clients to use Near Field Communication tags to allow tap-to-interact functionality for streamlined user engagement with physical objects or locations. Near Field Communication tags may also be linked with landing pages that may include useful information, activate features, or loyalty program enrollment, social media pages, or reviews or feedback forms. The platform may track Near Field Communication landing page access to track user engagement for insights and analytics to help optimize marketing efforts.

The platform allows clients to use location-based technology such as geofencing and Bluetooth beacons to improve client communications with users. Geofencing is a location-based technology that uses GPS, RFID (Radio Frequency Identification), or cellular data to create virtual boundaries or geographical zones around a specific location. These virtual perimeters can trigger automatic actions when a mobile device or object equipped with geofencing capabilities enters or exits the defined area. Geofencing allows businesses and developers to set up custom-defined geographical boundaries, and when a device or user enters or leaves those designated areas, predefined actions or notifications are triggered. Geofencing is widely used in various industries, including marketing, retail, transportation, and security.

Bluetooth beacons are small, low-power devices that use Bluetooth technology to transmit signals to nearby Bluetooth-enabled devices, such as smartphones or tablets. These beacons are designed to broadcast specific information or data to create location-based or proximity-based experiences for users. Bluetooth beacons work on Bluetooth Low Energy (BLE) technology, which allows them to operate for extended periods with minimal battery consumption. When a Bluetooth-enabled device comes within range of a beacon's signal, it can receive and process the transmitted data, triggering specific actions or providing relevant information to the user.

The platform may incorporate location-based technologies to wallet lock screens based on location, offering contextual information and promotions. Clients may target marketing campaigns for location-based services to increase conversion rates and user satisfaction or create notifications to keep client businesses top-of-mind for former customers when they walk or drive by. The platform may allow clients to create personalized and location-aware wallet passes that deliver relevant information and updates when users are near a client facility. The wallet pass may provide quick access to unit and facility information for users when they are at or near the facility, such as making payments or retrieving access codes. Clients can link facility access to the wallet pass incorporating geofencing and/or Near Field Communication technology to monitor and control access for users, ensuring only authorized individuals can enter the premises. Clients may also boost customer engagement and retention by offering location-based rewards or loyalty programs to encourage repeat visits and long-term customers. The platform tracks and analyzes location-based data to identify usage patterns, peak times, and areas of improvement. The platform allows and prompts clients to mark competitor locations to attract potential customers by creating content for timely offers, promotions, or incentives as they approach or visit competing facilities (for former or current users with installed wallet passes).

Eddystone-URL is a communication protocol developed by Google for Bluetooth Low Energy (BLE) beacons. It allows Bluetooth beacons to broadcast URLs that can be detected and opened by nearby Bluetooth-enabled devices, such as smartphones or tablets utilizing physical web applications. Eddystone-URL is specifically designed for delivering location-based web content or deep links to users in proximity to the beacons. Clients may use Eddystone URLs for displaying relevant information at places such as museums, aquariums, or zoos to enhance visitor experience.

In a particular embodiment, when a client accesses the platform, all necessary information is collected about the client and its locations. This can be performed manually by platform or client personnel or automatically from CRM data accessed through an appropriate API. Client information may include organizational structure, including the number of branches/sites, units, contact information, the number of employees, the type of services or products offered, and any unique requirements or challenges specific to each branch.

Once client information is gathered, a client account is established. The client may manage all locations and associated client data through the client account. The client account is integrated with ancillary platforms such as social media, marketing automation software, and client relationship management software. Branches are set up within the client's account based on the client data provided.

As an example of one application, in one embodiment, the trigger may be integrated into a number of different stations throughout a facility. An item that needs to be checked by a staff member or manager may have a trigger incorporated in or near the item. A staff member may perform an inspection of the item and scan the trigger with, for example, a mobile device such as a phone or tablet. Upon scanning the trigger, a prompt may be displayed to the staff member indicating a status of the item to the staff member. If the actual status of the item conforms to the status indicated in the system, the staff member may confirm that the status is as indicated. If the actual status of the item is different than that indicated in the system, the staff member may note the difference and change the status in the system to reflect the actual status of the item. The default status in the system may be that the item is clean, tidy, and in order and the staff member may confirm that everything having to do with the item is in order or may enter a note indicating anything that is out of the ordinary or not in order.

Facilities may develop a site visit checklist that includes all of the items that are to be confirmed in a supervisor visit. Items are confirmed by being scanned and any irregularities noted.

In another particular embodiment, the facility may be a storage facility with a plurality of spaces secured by a lock for each space. A trigger may be integrated into each lock and linked to a CRM that has an account status for the space that the lock secures. A staff member may perform a walk-through inspection scanning each lock in the facility. The CRM will have the status for the lock including whether the account for the space secured by the lock is active and current. If the account for the space secured by the lock is overdue, the staff member may place an overlock on the space to ensure that the account is made current before the user is allowed to access the space.

In another embodiment of the IoT interfacing with a CRM in the context of a storage facility, the storage facility may include sensors within each storage space. Sensors may include temperature sensors, humidity sensors, cameras, or lidar. Lidar is a remote sensing technology that uses laser light to measure distances and create detailed, accurate 3D maps of the surroundings. For privacy and other regulatory reasons, storage facilities frequently will not create images of the interior of a rented storage space. Lidar sensors may be used to scan the interior of a storage area and determine whether the storage space is occupied or unoccupied. The scan would not create an image of the space, but may scan the area and perform a binary analysis of whether any material is in the storage space or not. The lidar sensor allows the storage facility to determine if a tenant is using or has checked out of a particular space without requiring any input from the tenant.

In general, once the client account and branch/location data are established, content is created and templates are designed for the client. The content and templates may be consistent across all locations/branches and may include logos, images, fonts, and colors that represent the client's brand. Any content or templates that are not provided by the client are subject to client approval to meet client expectations and aligned with the client's brand guidelines. Once approval is obtained, necessary materials are printed and any IoT equipment is activated, such as sensors or smart devices that are required to operate the client's operations. Materials are kitted and shipped to designated locations for on-site setup. The system becomes live when some desired amount of on-site setup is complete, and the client activates the system.

In a particular embodiment, a platform is provided for storage clients to provide digital wallet passes to storage tenants. When a user accesses a wallet pass trigger, the user is prompted to enter user information such as the phone number of the mobile device on which the prompt is displayed in order to provide the user a OTP for security verification. The user may then select to add the wallet pass to the operating system's wallet application.

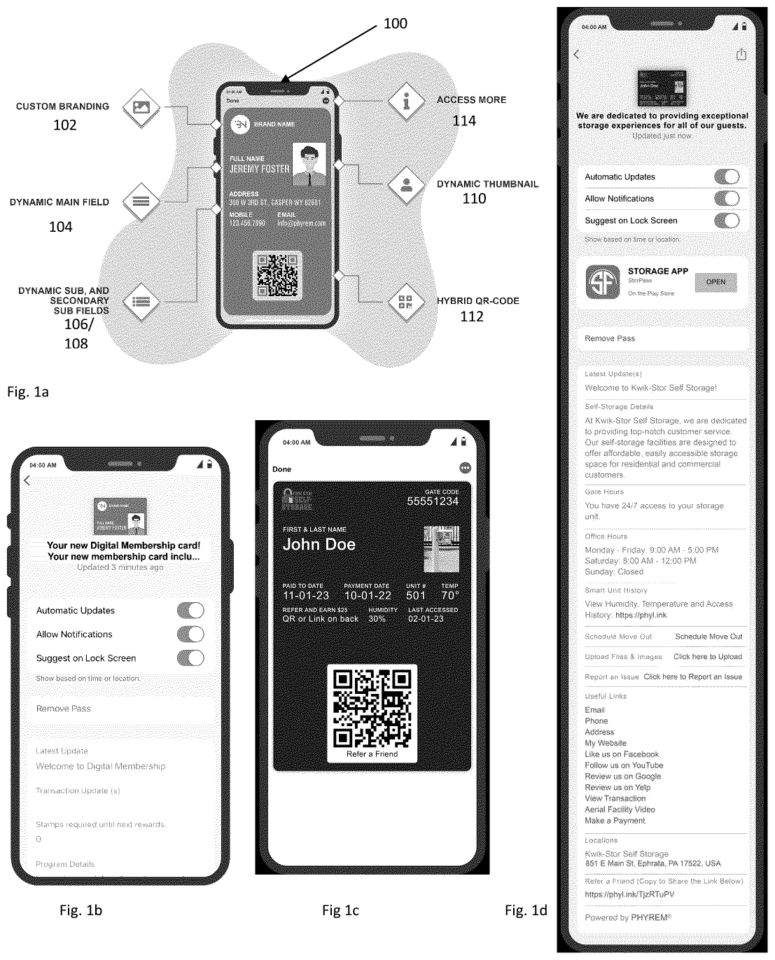

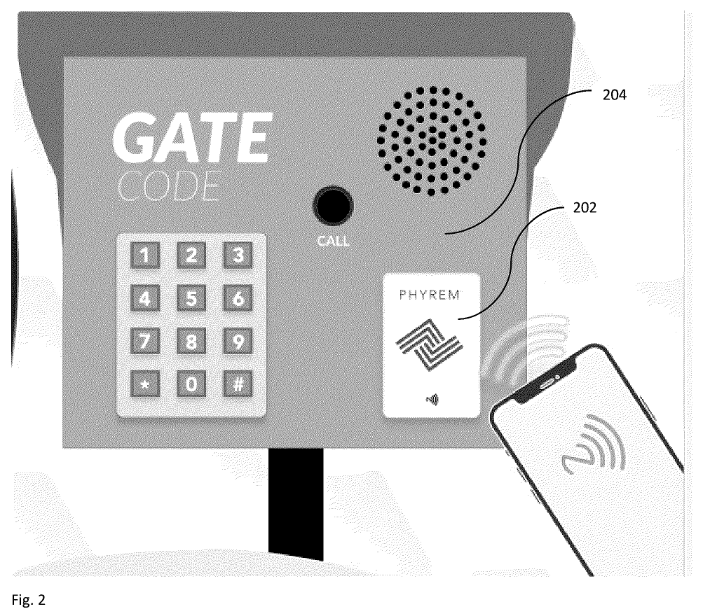

Referring to FIGS. 1a-d, a wallet pass generic pass template may be provided for clients to customize a wallet pass. The generic pass 100 may include a custom branding field 102 in which the client or user may place a logo or other branding marker. Custom branding promotes recognition, makes memorable impressions, and distinguishes clients from competitors. A dynamic main field 104 is the largest field on the pass 100 and may include an identifier such as the name of the user who is using the pass 100. Dynamic fields allow clients to accept input from users or accept information from client location management software. A dynamic thumbnail 110 may provide a photo of the user. A smaller, dynamic sub field 106 may include one or more secondary sub fields 108 and provide selected information for the user. A hybrid QR-code 112 allows the pass 100 to provide a link to a landing page selected by the client. such as referrals, sign-ups, or social media links. An access more field 114 allows the user to access additional settings that may be customized by the user. The Quick Response Code (a “hybrid” Quick Response Code) can double as a unique identifier (UID) for a tenant. The UID is associated with a tenant record and the tenant record has a status. Upon being scanned at a gate access point, the user is identified and the user is queried for its authorization status. If the authorization status is current, the gate is opened. Tenants or other third-parties such as security patrols, known vendors, or first responders may be authorized for entry.

Clients may enable or disable additional preferences such as automatic updates, notification allowance and suggestions on lock screen. A link to a synced app may be provided when the user selects the access more field that redirects the user to an app or the app store to allow the user to install/access the app linked to the pass. Additional useful links may also be provided such as social media, maps, payments, report issues, upload documents, share wallet access, or other useful links.

Clients may use the wallet passes for storage tenants to access gate codes, lock codes, payment information, referral Quick Response Codes or to consolidate essential details in one place. Storage clients may use platform templates to provide useful links, social media, and aggregator access or to schedule move-out, make payment, upload documents, or report issues. Platform APIs integrate with self-storage management software platforms.

The wallet pass may allow clients to have a Near Field Communication enabled pass at a gate and enable Near Field Communication-Enabled gate access control for storage facilities. Each tenant user may be provided a unique identifier linked to the user's Near Field Communication reader and SIM card gateway. The Near Field Communication reader and SIM card gateway may be integrated into a single device, or a separate Near Field Communication reader may communicate with a SIM card gateway. The platform allows the client to create Near Field Communication UID verification for seamless, contactless gate access. API integration with facility management platforms may confirm tenant identity and authorization status, ensuring access is granted only to authorized individuals and API communication with gate access control companies allows for real-time gate opening and closing through the wallet pass. The client may provide a Near Field Communication tag 202 at a physical gate access interface 204. By tapping their mobile device on the keypad, tenant users can trigger the gate to open.

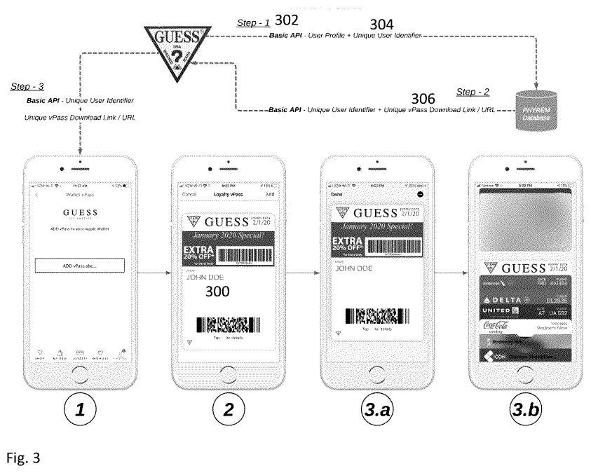

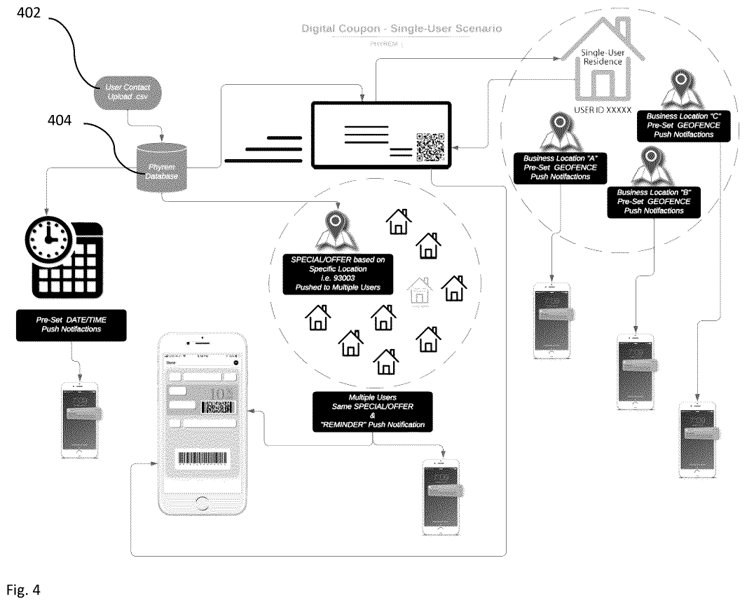

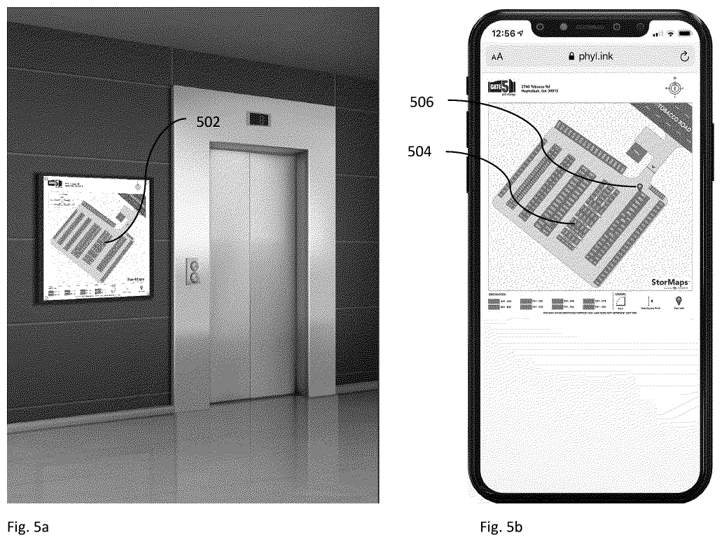

Referring to FIG. 3, a generic digital coupon template may be provided. The platform allows a client to create a user profile 302 with a unique user identifier 304 used to identify each individual user for the client's business. The client has a link or URL 306 associated with the client. User's access the client's link 306 and a unique user identifier 304 and the link or URL 306 is displayed on the user's device giving the user the option to download the coupon template 300. The coupon template is inserted into the user's wallet application and may be accessed by the user to gain access to specials and discounts provided by the client.

Referring to FIG. 4, a digital coupon in a single-user scenario is provided. User contact information 402 is collected in database 404. Clients may schedule notifications such as push notifications to be sent to users based on the address or geographical location of the user.

In one or more embodiments, Near Field Communication and Quick Response Code can be used for location check-in for client employees to ensure employee presence and accountability at designated spots. Clients can activate geotagging and location confirmation to maintain accurate and reliable check-in data for improved facility oversight and allow for automatic check-ins, minimizing manual intervention and increasing efficiency. In a particular embodiment, clients can strategically place Near Field Communication tags or Quick Response Codes throughout the property allowing personnel to “tap in” using the browser on their mobile device. The platform logs the date, time, and location of the tag or code “tapped” and may attach images uploaded by client personnel to the specific geo-location. Typical maintenance tasks such as lock checks, custodial tasks, and site visits may be verified through automated check-ins and/or by strategically deploying scannable tags throughout the property.

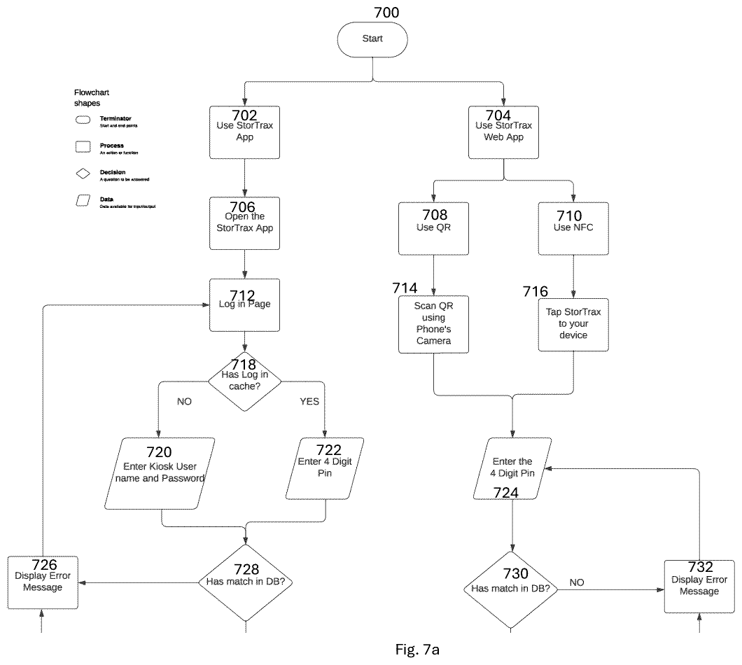

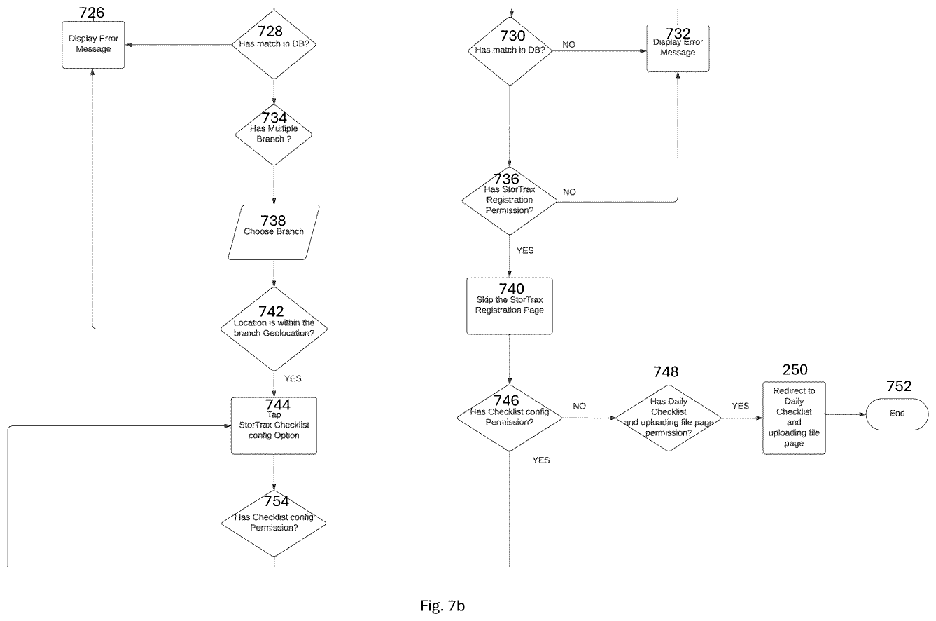

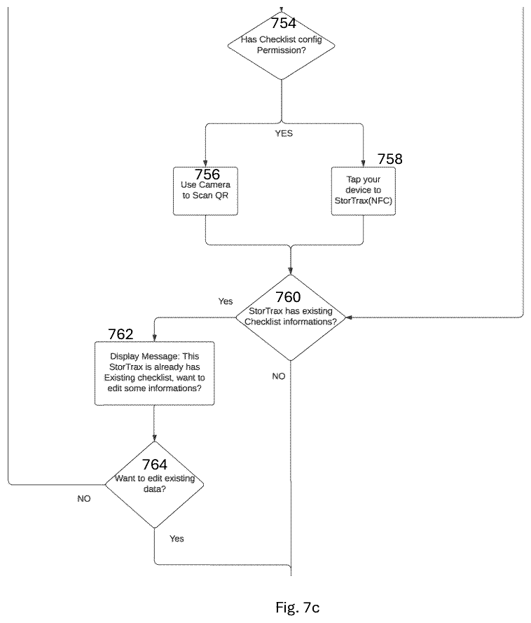

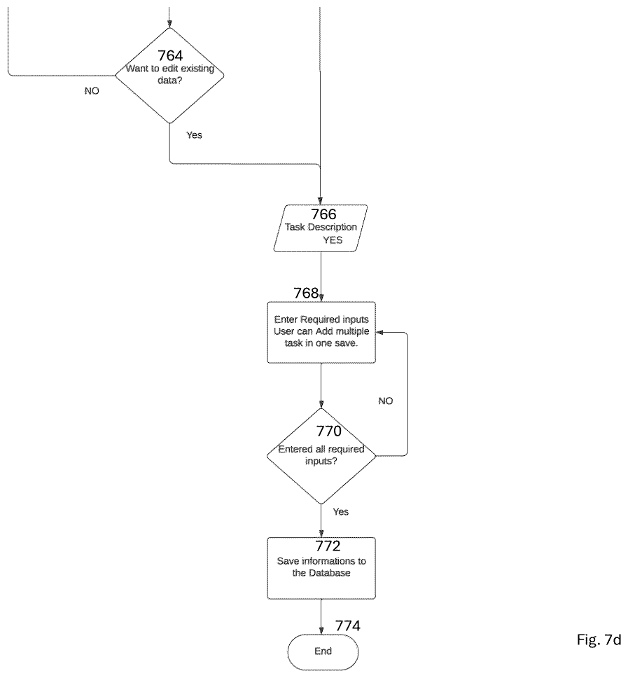

Referring to FIG. 7a-d, a flowchart is provided showing how to configure a system with typical tasks correlated with tags for site maintenance. The user can use an app 702 or web app 704 to configure the system. The system authenticates the user as able to configure the checklist system at 754 for the app and 746 on the web app. The user is able to configure and describe different tasks and save them to the system.

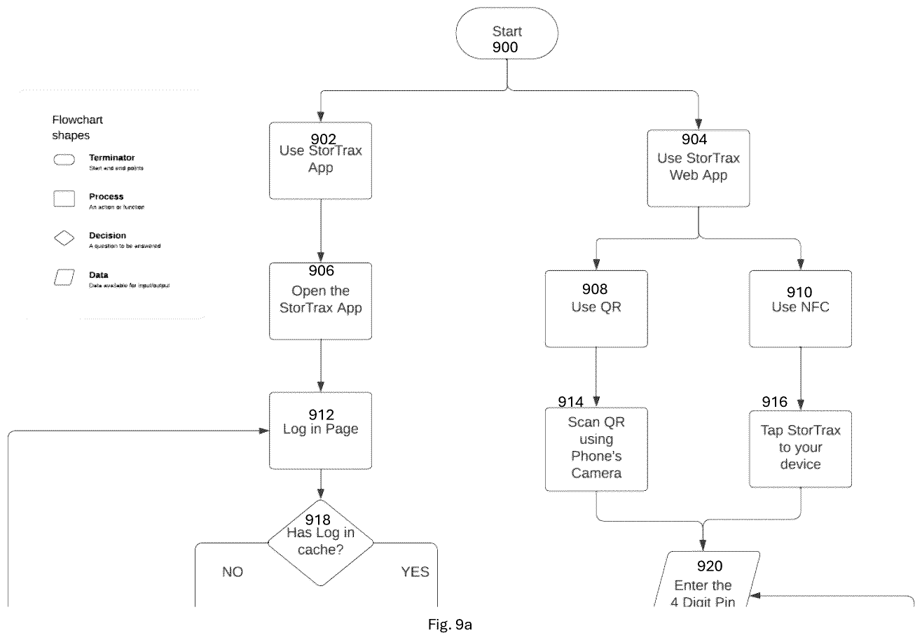

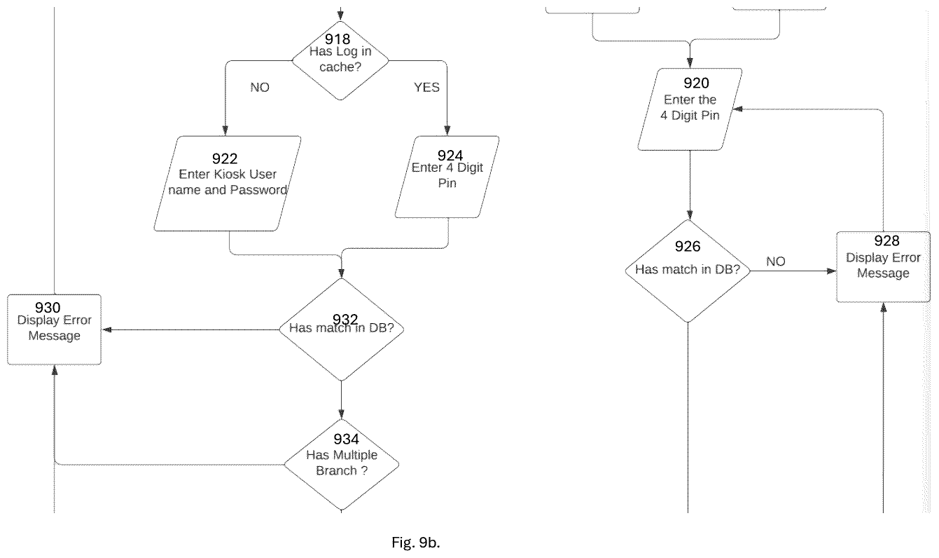

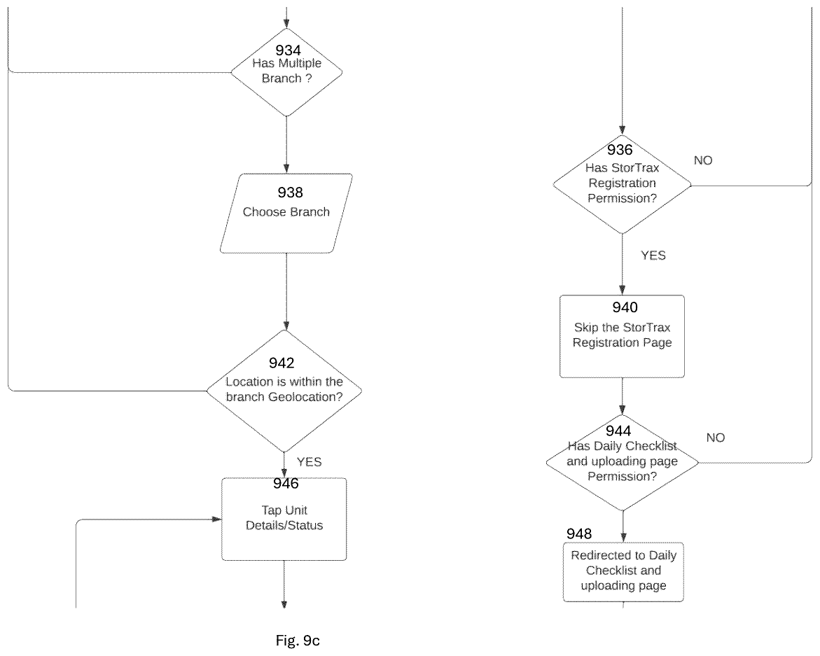

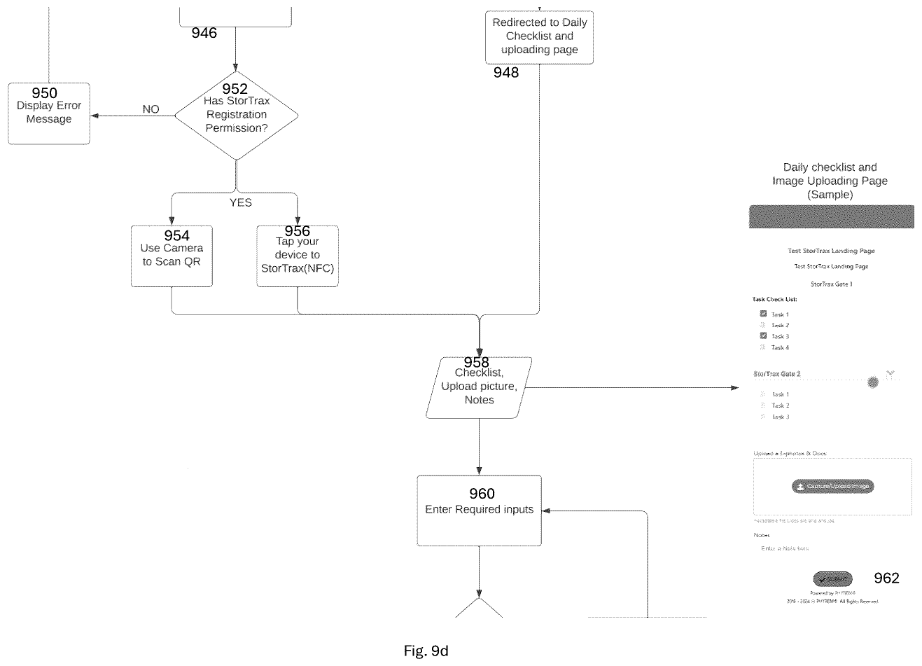

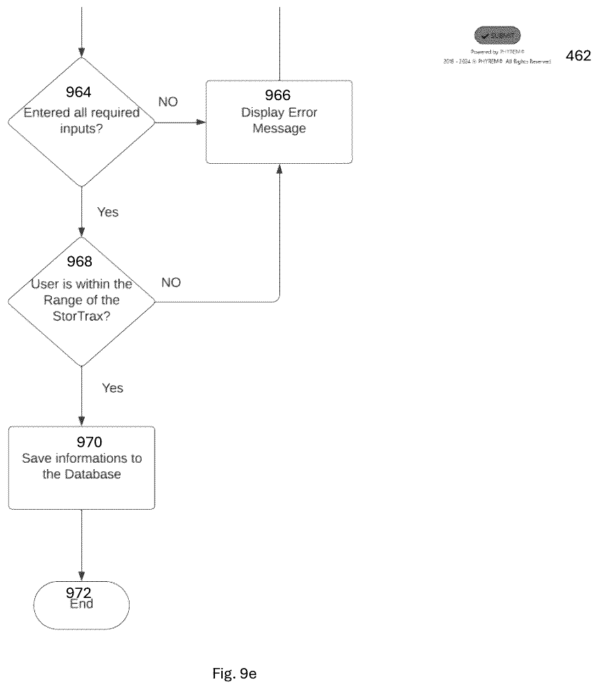

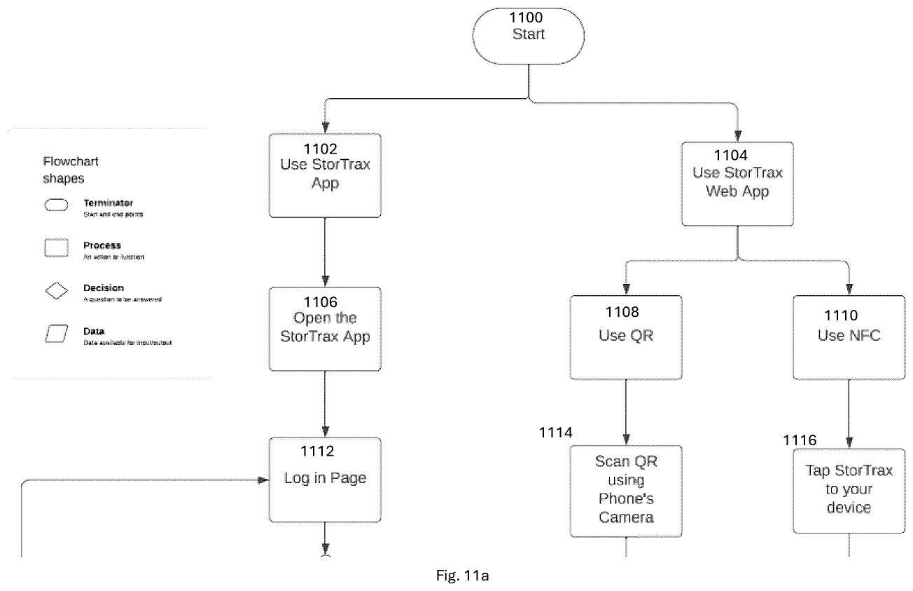

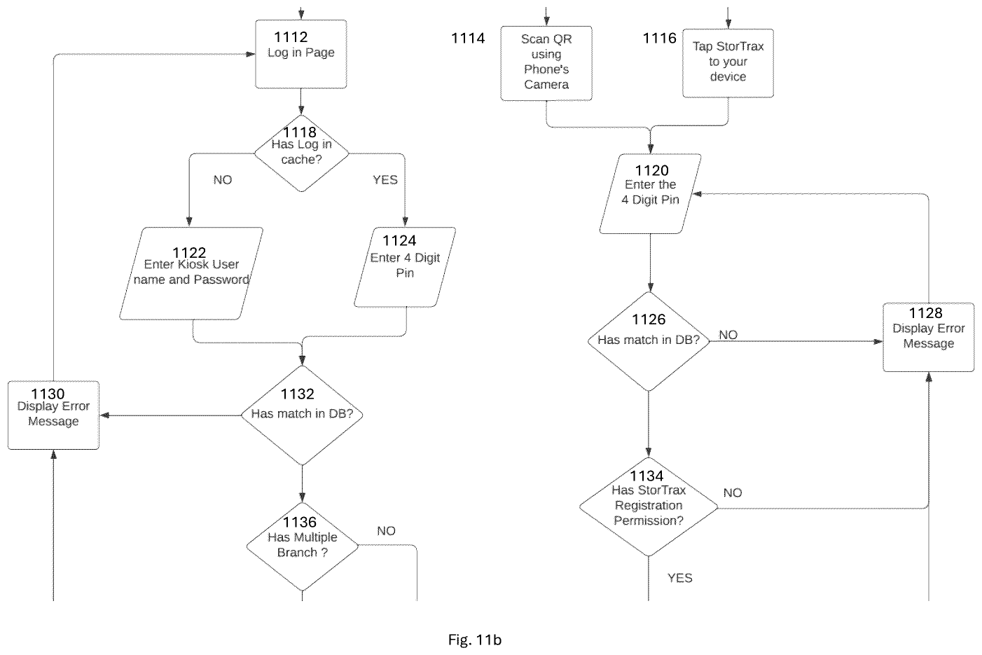

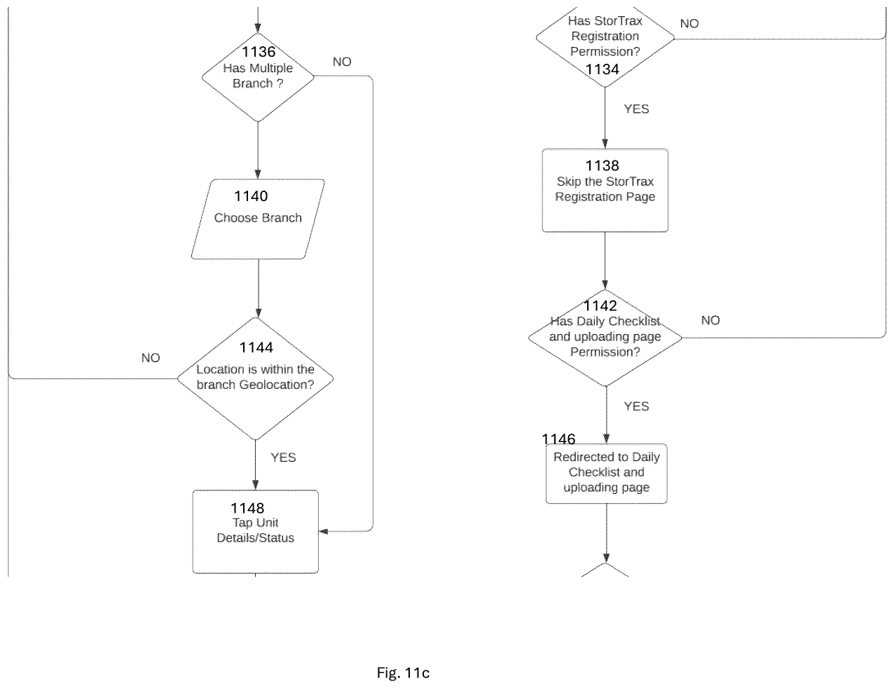

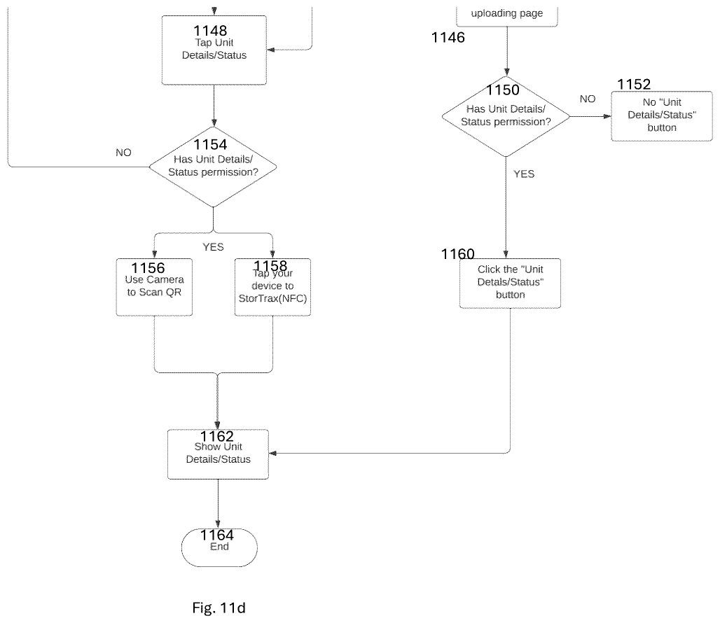

Once the system is configured, staff may go through the checklist and the system tracks performance of tasks on the checklist as shown in FIG. 9. The user logs in and taps a QR code or NFC tag and is taken to a daily checklist and uploading page 948. The user is able to update the checklist, upload pictures, and add notes at 958. The user enters all required inputs at 960 and the system confirms that the user is within the vicinity of the QR code or tag at 968 and saves the information at 970. The system allows a user to check in on the status of a site that is represented by a QR code or NFC tag as shown in FIG. 11. The user is authenticated, the QR code scanned or NFC tag tapped and the status of the site is displayed to the user.

The platform allows clients to use location-based technology and mapping on wallet pass applications. For example, wallet passes may include digital and physical map features for storage facilities. Tenant users can navigate storage facilities, find, and access their units from the wallet pass created by a client on the platform. Referring to FIG. 5, a physical map 502 may be provided with “You Are Here” stickers. Additionally, actions triggered by Near Field Communication, Quick Response Code, or location-based technologies will allow users to pull up their mobile device and access a digital copy of the map. A copy of the map 504 may be displayed on the user's device along with an indicator 506 that highlights a desired location (such as the user's storage unit, entrances, exits, elevators, stairwells, loading docks, or other features) on the same map. The platform may allow clients to create and provide digital maps with unique map layers for each tenant user's unit. The platform may allow users to search to locate another desired unit, a bathroom, the front desk, or other feature.

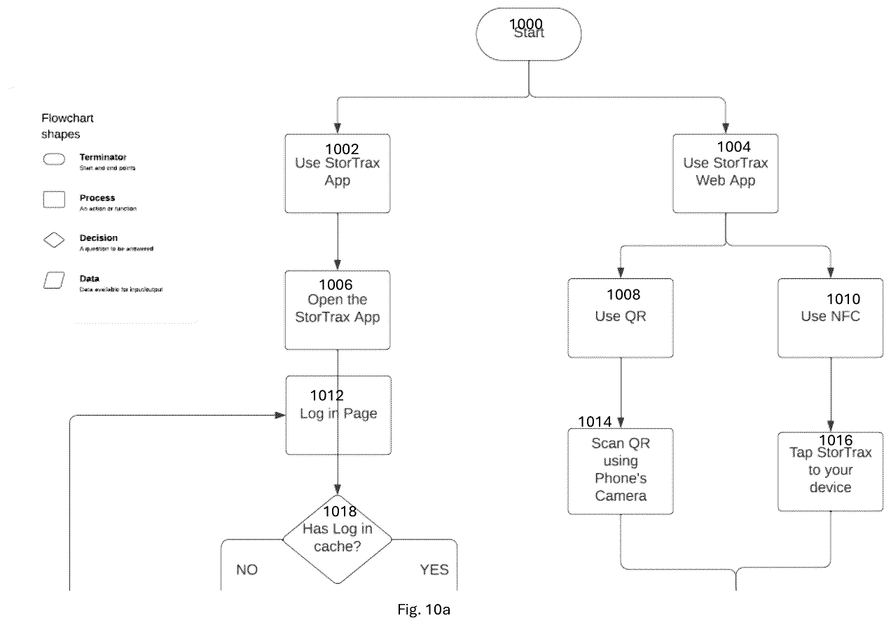

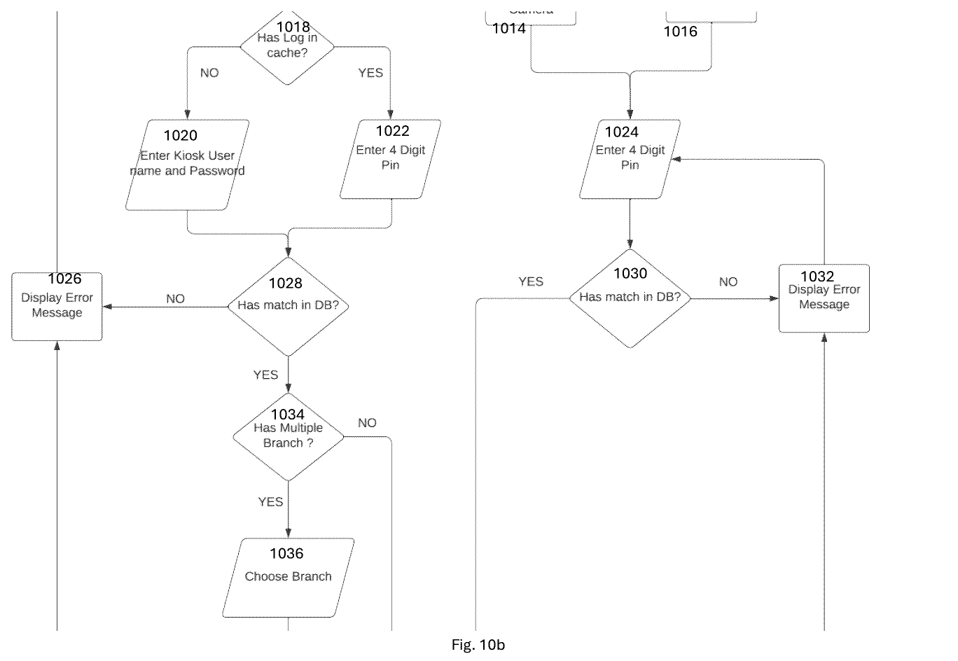

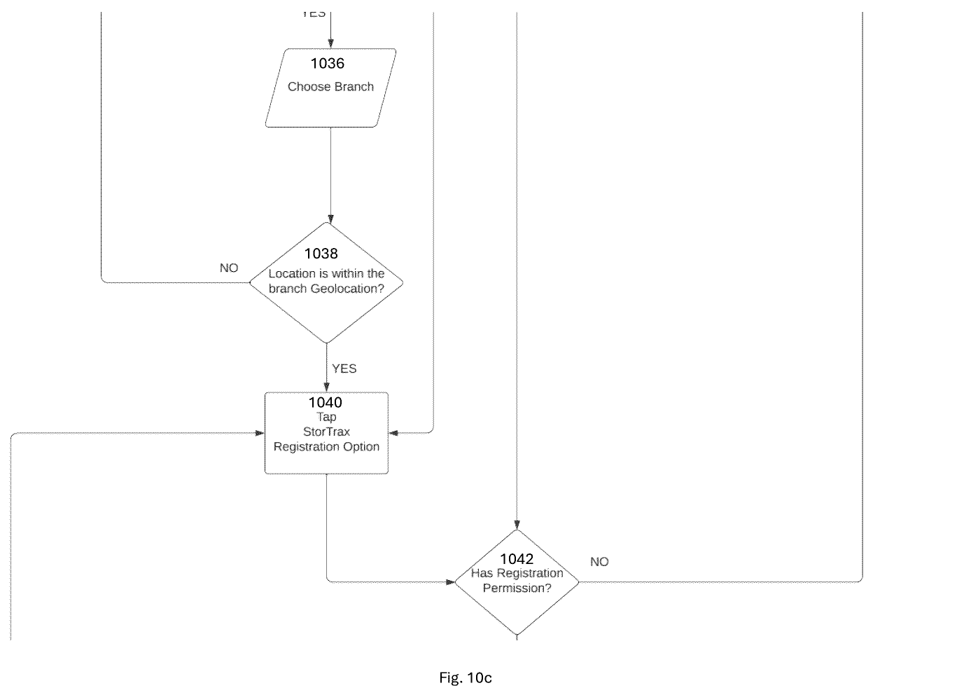

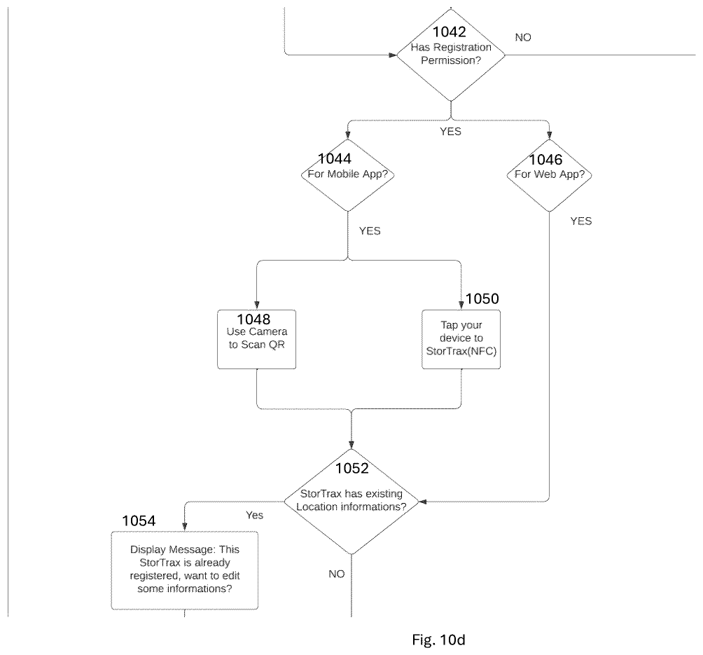

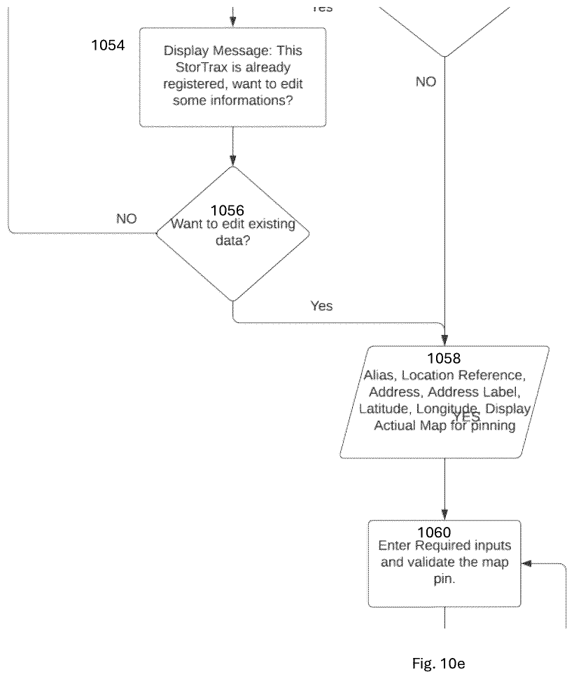

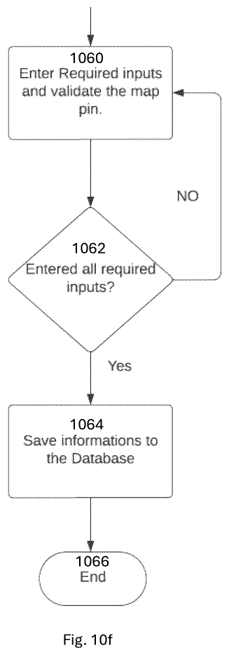

A user is able to enter location information for a unit, QR code, or tag as shown in FIG. 10. For a web app, the user uses the QR code or NFC tag at 1008 and 1010 and then logs in using a 4 digit pin at 1024. For the app, the user logs in first at 1020 or 1022 and then chooses a branch 1036 if there are multiple branches. The app checks to confirm that the app's location is within the selected branch's geolocation at 1038. Once the geolocation is confirmed, the user of the app scans a QR code 1048 or taps their device to an NFC tag at 1050. An authenticated user can edit the alias, location reference, address, address label, latitude, longitude or the system can display a map for printing at 1058. The user enters any required inputs and validates the map pin at 1060 and information is saved to the database.

The platform provides clients with facility monitoring solutions with IoT-enabled devices for enhanced security and maintenance. Clients may be provided with a sensor pack that can be integrated into wallet pass applications. In one or more embodiments, sensor packs may be run on an ISM (Industrial, Scientific, and Medical) network that operates in the unlicensed ISM radio frequency bands. The frequency can be 5.8 GHZ, 2.4 GHz, 915 MHZ, or any other suitable ISM frequency. The sensor pack can include at least one of a motion sensor, humidity sensor, temperature sensor, and water sensor. The motion sensor may have adjustable sensitivity, detecting movements from small animals to adult humans. Motion, humidity, temperature, and water detection may be used to provide alerts to client personnel when levels are detected outside of acceptable value ranges without creating a web application or complex personnel management system. Clients may allow users to access sensor pack data for transparency and customer satisfaction or may allow users to adjust alert levels for specialized applications. The platform may employ API-driven communication with management software platforms for efficient facility management and maintenance.

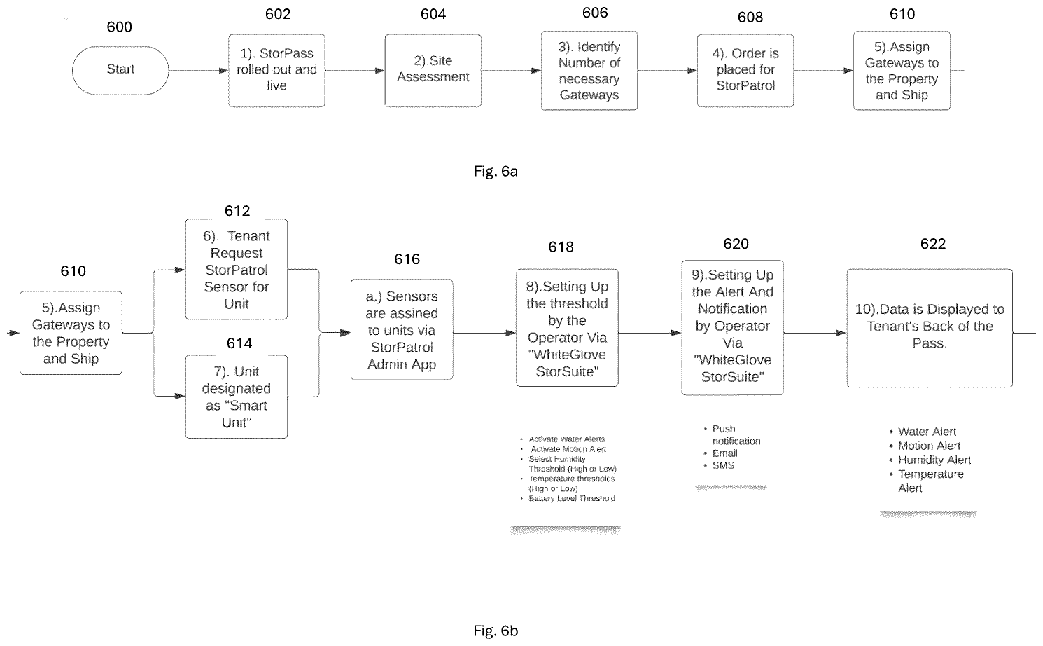

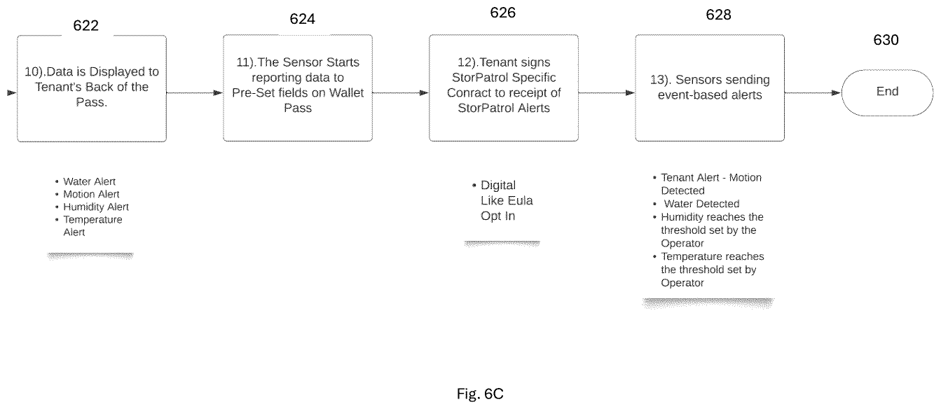

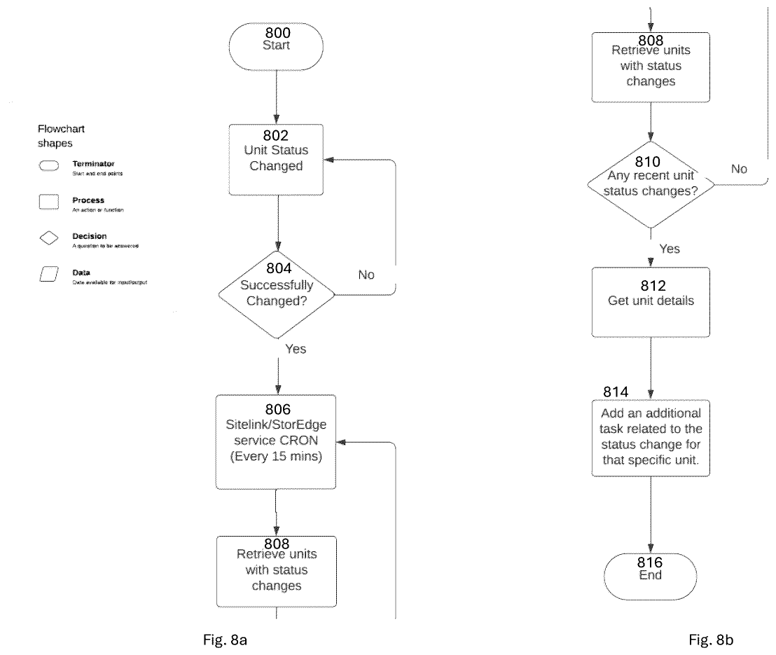

R Referring to FIG. 6a-c, a site assessment 604 is performed to identify the number of appropriate gateways 606. Gateways are assigned to the property at 610. Tenants may request sensors for their unit at 612 and the unit is designated as a smart unit at 614. Sensors are assigned 616 and an operator sets up alert and notifications settings for the unit at 620. Data for the unit is displayed to tenants at 622. Sensors report data to pre-set fields at 624 and may send even based alerts at 628. Referring to FIG. 8a and b, a flowchart is provided that shows the process when a status change is detected.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. The terms “including” and “such as” are not limiting and should be interpreted as “including, but not limited to,” and “such as, for example,” respectively. Moreover, any combination of the above-described embodiments in all possible variations thereof is encompassed by the disclosure unless otherwise indicated herein or otherwise clearly contradicted by context.

I claim:

1. A client-user interaction platform for allowing a client to interact with one or more storage unit users associated with the client through a mobile device having an operating system and an operating system wallet application, the platform comprising:
a client interface that is accessible by one or more managers selected by the client;
a set of creation tools provided through the platform that allow the client to create custom wallet app or other content;
one or more triggers that are each associated with and accessible by at least one of the one or more users;
a linker allowing the client to associate the one or more triggers with the wallet app or other content.

2. The client-user interaction platform of claim 1, further comprising a tracker that logs user interactions with the one or more triggers or with the wallet app content.

3. The client-user interaction platform of claim 1, wherein the one or more triggers is at least one of a Bluetooth beacon, a Quick Response Code, a 2-way SMS, a Near Field Communication tag, a geographical location, and a trackable link.

4. The client-user interaction platform of claim 1, wherein the set of creation tools comprises at least one of a wallet pass builder, a landing page builder, and an email template builder.

5. The client-user interaction platform of claim 2, wherein the wallet app content comprises one or more campaign items.

6. The client-user interaction platform of claim 5, wherein the campaign items are at least one of an email, SMS, or push notification scheduled to a marketing strategy that adapts to user preferences, behaviors, and engagement patterns.

7. The client-user interaction platform of claim 1, further comprising a wallet pass API mapper.

8. The client-user interaction platform of claim 1, further comprising a map tool that allows the client to create a custom geographic or location map.

9. The client-user interaction platform of claim 8, wherein at least one of the one or more triggers is depicted on the map.

10. The client-user interaction platform of claim 2 further comprising a graphical depiction of the logged interactions.

11. The client-user interaction platform of claim 1 further comprising a dashboard summarizing the clients content, triggers, and users.

12. The client-user interaction platform of claim 1, wherein the client has a plurality of locations, and wherein the content is customized to at least one of the plurality of locations.

13. The client-user interaction platform of claim 4, wherein the wallet pass builder comprises at least one wallet pass template.

14. The client-user interaction platform of claim 13, wherein the at least one wallet pass template is selected from the group consisting of a generic pass, a storage pass, a loyalty pass, a coupon pass, a member pass, an event ticket pass, a store pass, and a transit pass.

15. The client-user interaction platform of claim 4, wherein the landing page builder comprises at least one landing page template.

16. The client-user interaction platform of claim 15, wherein the at least one landing page template is selected from the group consisting of redirection page, a registration page, a payment page, a social media link, an issue reporting page, a photo gallery, an audio link, a vCard, a social media react page, a rate and review page, a feedback page, a video, an email us page, a text us page, a wifi login page, a business page, a maps page, an iFrame page, and a multiple links page.

17. The client-user interaction platform of claim 4, wherein the email template builder comprises at least one email template.

18. The client-user interaction platform of claim 17, wherein the at least one email template is selected from the group consisting of at least one of a holiday email, a basic announcement email, a basic letter email, a birthday email, a newsletter email, a special offer email, and a sign up email.

19. The client-user interaction platform of claim 1 further comprising at least one sensor, wherein information from the sensor is incorporated into the custom wallet app content. 20 The client-user interaction platform of claim 19, wherein the at least one sensor is at least one of a motion sensor, a humidity sensor, a temperature sensor, and a water sensor.

21. The client-user interaction platform of claim 1, wherein the client is a storage facility, the one or more triggers are Near Field Communication tags and wherein the wallet app content allows gate access to a user.

22. A method of managing a plurality of storage units, each storage unit leased by a tenant, the method comprising the acts of:
providing the platform of claim 1, wherein the client of the platform is the owner or operator of the plurality of storage units, and wherein one of the one or more triggers is a first trigger and wherein the first trigger is a Near Field Communication tag;
enrolling the tenants as users of the platform and assigning the user a unique user identifier;
linking the user identifier to at least one gate;
configuring the at least one gate to open when the mobile device of the tenant is placed in proximity to the Near Field Communication tag.

23. The method of claim 22, wherein at least one of the one or more triggers is a second trigger, and wherein the second trigger is an Near Field Communication tag or Quick Response Code, the method further comprising:
enrolling staff of the client as users of the platform and logging staff activation of the second trigger.

24. The method of claim 23 further comprising allowing staff to attach images to a log record of activation of the second trigger.

25. A method of facilitating visits to a storage unit site, the method comprising the acts of:
providing the platform of claim 1, wherein the wallet app content comprises a map and customized locations of interest for each user identified on the map;
providing a printout of the map at the site and a trigger on or near the printout, wherein the trigger when activated by the user initiates a display of the map on the user's mobile device with the locations of interest of the user highlighted.

26. The method of facilitating visits to a site of claim 25, wherein the trigger is an Near Field Communication tag, Quick Response Code, geofence, or Bluetooth beacon.
